(19) United States
(12) Patent Application Publication
(10) Pub. No.: US 2005/0228914 A1
(43) Pub. Date: Oct. 13, 2005

(54) Matrix type bus connection system

(75) Inventor: Keitaro Ishida, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 10/991,500

(22) Filed: Nov. 19, 2004

(30) Foreign Application Priority Data
Apr. 13, 2004 (JP) 2004-118027

(51) Int. Cl. G06F 13/00

(52) U.S. Cl. 710/110

(57) ABSTRACT

A matrix type bus connection system has a plurality of master devices and a plurality of slave devices. Each slave device has an arbitration circuit. The arbitration circuit stores an address of a master device that made the access the last time, and continues holding a select signal to a selector when access ends. If a new connection request is received, the arbitration circuit compares the address of the master device that is now making the access request with the address of the master device that made the access the last time. If the connection request is from the same master device, a connection control is not performed. The previous connection status is maintained. Thus, the master device can be connected to the slave device without a delay.

### BACKGROUND OF THE INVENTION

1. Field of the Invention

The present invention relates to a matrix type bus connection system that includes a plurality of master devices and a plurality of slave devices connected in a desired manner, so that the master devices can operate simultaneously.

2. Description of the Related Art

FIG. 2 of the accompanying drawings is a block diagram of a conventional matrix type bus connection system.

This matrix type bus connection system includes a plurality of master devices 1ᵢ (i=1 to m), a plurality of slave devices 2ⱼ (j=1 to n), and a matrix type bus circuit 10 for connecting these devices arbitrarily.

In principle, the matrix type bus circuit 10 includes a plurality of dedicated buses installed for the master devices 1ᵢ (each bus is referred to as “master bus” or “bus of the master device”) and a plurality of dedicated buses installed for the slave devices 2ⱼ (each bus is referred to as “slave bus” or “bus of the slave device”), and the master buses crisscross the slave buses. Each master device has its own master bus, and each slave device has its own slave bus. The matrix type bus circuit 10 controls connection at crossing points of the master and slave buses in response to the access requests from the master devices.

Each master device 1ᵢ has a decoder (DEC) 11ᵢ and selector (SEL) 12ᵢ, provided on the master bus respectively, and each slave device 2ᵢ has an arbitration circuit (ARB) 13ⱼ and selector 14ⱼ, provided on the slave bus respectively.

The decoder 11ᵢ specifies a connection target slave device 2ⱼ by analyzing the address supplied from the master device 1ᵢ, and sends the access request to the arbitration circuit 13ⱼ of the slave device 2ⱼ. The arbitration circuit 13ⱼ determines which access request should be accepted (i.e., which master device should be connected) based on the priority and order of the access requests sent from the decoders 11ᵢ, and controls the selector 12ᵢ of the master device concerned and the selector 14ⱼ of the slave device concerned.

FIG. 3 in the accompanying drawings depicts the basic operation of the bus protocol in the matrix type bus connection system shown in FIG. 2.

The master device 1ᵢ issues the data transfer destination address addr, transfer type trans and transfer count information burst to the matrix type bus circuit 10. The address addr is a unique identification number assigned to each slave device 2ⱼ. The transfer type trans indicates whether the specified address addr is continuous, and “SEQ” is output if it is continuous, and “NSQ” is output if not. The transfer count information burst indicates the number of times of data transfer, and “FIXED” is output if the transfer count is predetermined, and “INCR” is output if not.

The slave device 2ⱼ specified by the master device lᵢ supplies a “ready” signal to the master device when the data transfer to the slave device is possible.

The operation of this matrix type bus connection system will now be described using the case of accessing from the master device 11 to the slave device 2ₙ.

The master device 1₁ outputs the address addr of the slave device 2ₙ to the associated master bus. This address addr is read and analyzed by the decoder 11₁ of the master device 1ₗ, and the access request is issued from this decoder 11₁ to the arbitration circuit 13ₙ of the slave device 2ₙ.

In the arbitration circuit 13ₙ, the access request from the master device 1₁ is held by an access request holding unit (not shown). If an access request is sent from another master device 1ₓ at this time, this access request is also held by the access request holding unit. The access request, which has the highest priority among access requests held in the access request holding unit, is selected by the priority judgment unit (not illustrated), and the access of the master device (master device 1₁ in this case) which has issued the access request of the highest priority is permitted.

When the access is permitted by the arbitration circuit 13ₙ of the slave device 2ₙ, this arbitration circuit 13ₙ outputs the select signal for connecting the bus of the master device 1₁ to the selector 14ₙ, and outputs the select signal for connecting the bus of the slave device 2ₙ to the selector 12₁ of the master device 1₁. Thus, the master device 1₁ is connected to the slave device 2ₙ.

When the connection is made, the master device 11 supplies the address addr, data transfer type trans, and transfer count information burst to the slave device 2ₙ, and the slave device 2ₙ returns the reply signal ready to the master device 1ₗ. Then the data transfer is executed according to the specified transfer type.

In this way, the matrix type bus circuit 10 connects the bus of the master device 1ᵢ to the bus of the slave device 2ⱼ. Thus, the master device 1ᵢ can connect to an arbitrary slave device 2ⱼ as long as the connection target slave device 2ⱼ is not yet connected to another master device 1ᵢ.

The above described bus connection system is disclosed in Japanese Patent Kokai (Laid-open Application) Nos. 5-120221, 7-210501 and 2003-30133.

FIG. 4 of the accompanying drawings is an operation timing chart depicting the problems of the bus connection system shown in FIG. 2.

In FIG. 4, one cycle is required from the cycle T15 when the master device 1₁ issues the access request signal req1to0 to access the slave device 2ₗ, to the cycle T16 when the arbitration circuit 13₁ of the slave device 2₁ receives this request signal, and the access enable signal active1to0 for the master device 1₁ to access to slave device 2₁ is generated. Therefore the access which the master device 1₁ requests to the slave device 2₁ in the cycle T15 is started at this slave device 2₁ in the cycle T16. This means that a one cycle delay always occurs even when access is repeated to the same slave device 2ₗ.

### SUMMARY OF THE INVENTION

It is one object of the present invention to provide a matrix type bus connection system which does not generate a delay when a master device repeatedly accesses the same slave device.

According to one aspect of the present invention, there is provided an improved matrix type bus connection system. This matrix type bus connection system includes a plurality of master devices, a plurality of first dedicated buses extending from the master devices respectively, a plurality of slave devices, and a plurality of second dedicated buses extending from the slave devices respectively. Each master device is able to request connection to a connection target slave device among the slave devices by outputting an address of the connection target slave device to the associated first dedicated bus. When connection is established between the first dedicated bus of the master device concerned and the second dedicated bus of the slave device concerned, the slave device is able to transfer data to the master device that has requested the connection through the associated first and second dedicated buses. A plurality of decoders are associated with the master devices respectively such that the decoder of the master device concerned analyzes the address of the connection target slave device issued from the master device to specify the connection target slave device, and to output a connection request signal to the connection target slave device. A plurality of arbitration circuits are associated with the slave devices respectively such that the arbitration circuit of the slave device concerned performs connection control to establish the connection between the first dedicated bus of the master device and the second dedicated bus of the slave device and issues a select signal based on the connection request signal provided by the decoder of the master device. This matrix type bus connection system includes a selector for connecting, according to the select signal provided by the arbitration circuit of the slave device concerned, the first dedicated bus of the master device concerned and the second dedicated bus of the slave device concerned. The arbitration circuit stores an address of the master device that has now established the connection to the connection target slave device. When receiving a connection request from the same master device again, the arbitration circuit omits the connection control.

The arbitration circuit disposed for each slave device stores the address of the master device which has made the connection most recently. If the arbitration circuit receives a connection request again from the same master device, the connection control between the master device and slave device based on that connection request signal is omitted. In other words, the previous connection status is maintained. Therefore, when a data transfer is carried out again between the same master device and same slave device, the bus of the master device and the bus of the slave device are immediately (or instantaneously) connected. Accordingly, time for the bus connection is unnecessary, and an access delay can be eliminated.

Each arbitration circuit may have a storage for keeping the select signal for the selector even after the access ends. This select signal is used again when the connection request is supplied from the same master device.

These and other objects, aspects and advantages of the present invention will become apparent to those skilled in the art from the following detailed description and appended claims when read and understood in conjunction with the accompanying drawings.

### BRIEF DESCRIPTION OF THE DRAWINGS

FIG. 1 is a block diagram depicting a matrix type bus connection system according to one embodiment of the present invention;

FIG. 2 is a block diagram depicting an overview of a conventional matrix type bus connection system;

FIG. 3 is a diagram depicting the basic operation of the bus protocol in the matrix type bus connection system shown in FIG. 2;

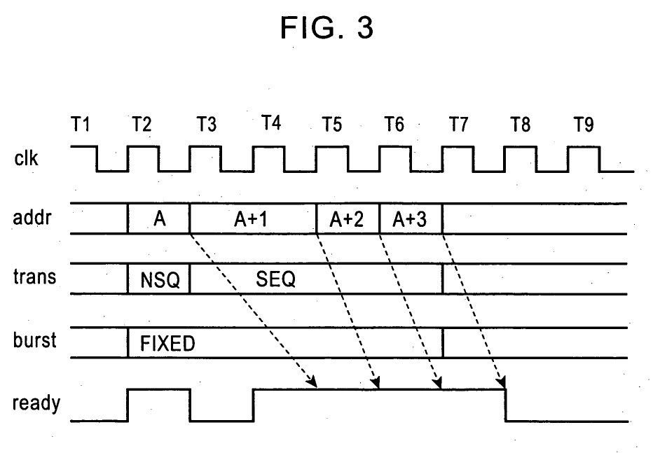

FIG. 4 is an operation timing chart depicting the problems of the bus connection system shown in FIG. 2; and

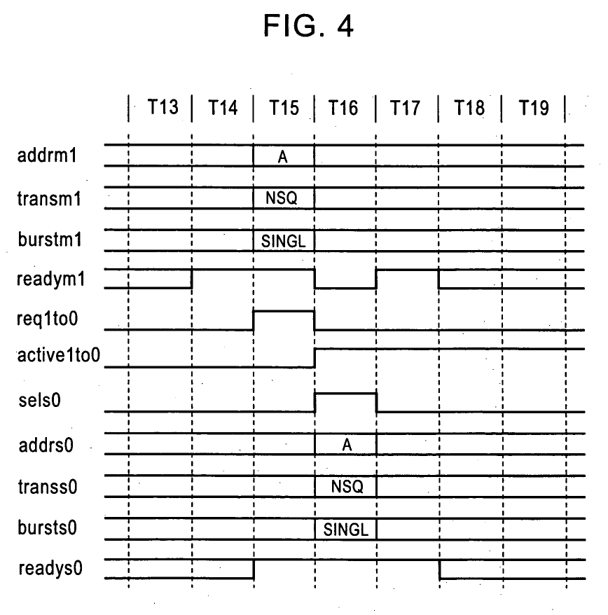

FIG. 5 is a diagram depicting an example of the operation timing of the bus connection system shown in FIG. 1.

### DETAILED DESCRIPTION OF THE INVENTION

An embodiment of the present invention will be described with reference to the accompanying drawings. It should be noted that the drawings are merely for description, and do not limit the scope of the present invention.

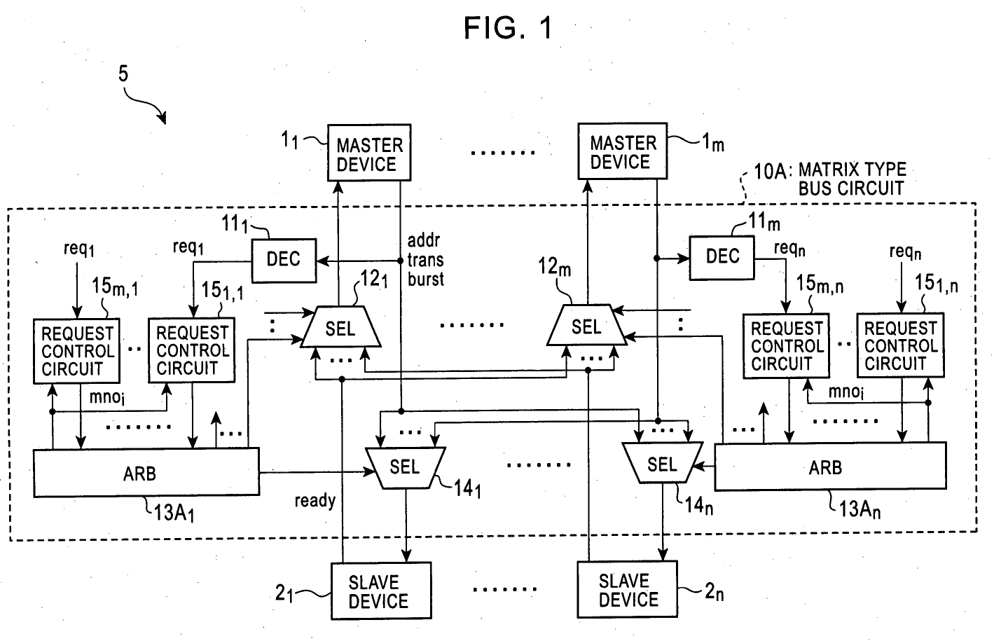

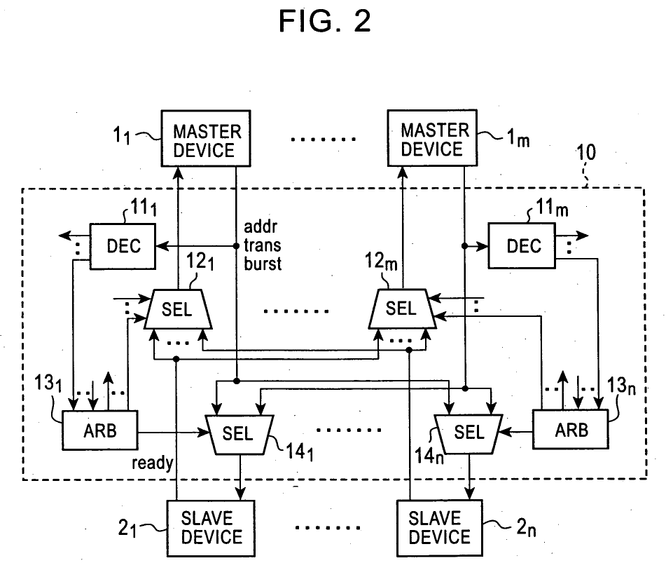

Referring to FIG. 1, a matrix type bus connection system 5 according to one embodiment of the present invention will be described. It should be noted that similar elements in FIG. 1 and FIG. 2 are denoted with the similar reference symbols.

This matrix type bus connection system 5 includes a plurality of master devices 1ᵢ (i=1 to m) and a plurality of slave devices 2ⱼ (j=1 to n) which are similar to those in FIG. 2, and a matrix type bus circuit 10A, of which configuration is different from that in FIG. 2, for arbitrarily connecting the master and slave devices.

The master device 1ᵢ can specify an access target device (one of the slave devices 2ⱼ) by outputting an address addr. The master device is, for example, a CPU (Central Processing Unit) or DMA (Direct Memory Access). The slave device 2ⱼ is an input/output device and storage device, for example. The slave device 2ⱼ is specified by the address addr and accepts access from the master device 1ᵢ.

Each master device has a dedicated bus (referred to as “master bus” or “bus of the master device”) and each slave device has a dedicated bus (referred to as “slave bus” or “bus of the slave device”).

The matrix type bus circuit 10A includes decoders (DEC) 11ᵢ, selectors (SEL) 12ᵢ, arbitration circuits (ARB) 13Aⱼ and selectors (SEL) 14ⱼ. The decoders 11ᵢ and selectors 12ᵢ are provided on the respective master buses, and the arbitration circuits 13Aⱼ and selectors 14ⱼ are provided on the respective slave buses. In other terms, the decoders 11ᵢ and selectors 12ᵢ are associated with the respective master devices 1ᵢ, and the arbitration circuits 13Aⱼ and selectors 14ⱼ are associated with the respective slave devices 2ᵢ. The matrix type bus circuit 10A also includes request control circuits 15_{i,j} which are disposed for the respective pairs of the master devices 1ᵢ and slave devices 2ⱼ.

The decoder 11ᵢ specifies a connection target slave device 2ⱼ by analyzing the address supplied from the master device 1ᵢ, and sends the access signal reqᵢ to the request control circuits 15_{i,j} associated with the slave device 2ⱼ.

The request control circuits 15_{i,j} sends an access request to the slave device 2ⱼ according to the later mentioned logic, based on the access signal reqᵢ received from the decoder 11ᵢ and the current master number mnoⱼ received from the arbitration circuit 13Aⱼ.

The arbitration circuit 13Aⱼ has a memory for storing the number of the master device lᵢ which is now making an access request or which made an access request the last time, and supplies this number of the master device 1ᵢ to the request control circuits 15_{i,j} as the current master number mnoⱼ. Similar to the conventional arbitration circuit 13ⱼ, the arbitration circuit 13Aⱼ determines which master device's access request should be permitted (accepted) based on the priority and order of the access request from the decoders 11ᵢ. The arbitration circuit 13Aⱼ then controls the selector 12ᵢ of the master device 1ᵢ and the selector 14ⱼ of the slave device 2ⱼ. This control is referred to as connection control. The priority of the access request is determined by the arbitration circuit 13Aⱼ.

The selector 12ᵢ selects a bus of the slave device 2ⱼ according to the select signal provided by the arbitration circuit 13Aⱼ, and connects the selected bus to the bus of the master device 1ᵢ. The selector 14ⱼ selects the bus of the master device 1ᵢ according to the select signal provided by the associated arbitration circuit 13Aⱼ, and connects the selected bus to the bus of the slave device 2ⱼ.

Table 1 shows the operation logic of the request control circuit 15_{i,j}.

TABLE 1
Operation logic of request control circuits 15_{i, j}

| | | Access request to |
|---|---|---|
| Current master | Access signal | arbitration circuit |
| number (mno) | (reqi) | 13Aⱼ |
| =i | * | Doesn't exist |
| ≠i | Exists | Exists |
| ≠i | Doesn't exist | Doesn't exist |

* means “don't care”.

As Table 1 shows, if the address (=i) of the master device 1, which specified by the access signal reqᵢ provided to the request control circuit 15_{i,j}, is the same as the current master number mnoⱼ (=j) provided from the arbitration circuit 13Aⱼ, the request control circuit stops (does not issue) the access request to the arbitration circuit 13Aⱼ. If the address (=i) of the master device 1 is different from the current master number mnoⱼ (=j), on the other hand, the request control circuit 15 outputs the access request to the arbitration circuit 13Aⱼ. If the access signal reqᵢ does not exist, then the access request is not supplied to the arbitration circuit 13Aⱼ.

In this matrix type bus connection system 5, the number of the master device 1ᵢ, which made the access last time, is stored as a current master number mnoⱼ, in the arbitration circuit 13Aⱼ of the slave device 2ⱼ. If the same master device 1ᵢ requests access again, the request control circuit 15_{i,j} masks the access request to the arbitration circuit 13Aⱼ. As a result, the arbitration operation in the arbitration circuit 13Aⱼ is omitted. No change is made to the signal that is supplied from the arbitration circuit.

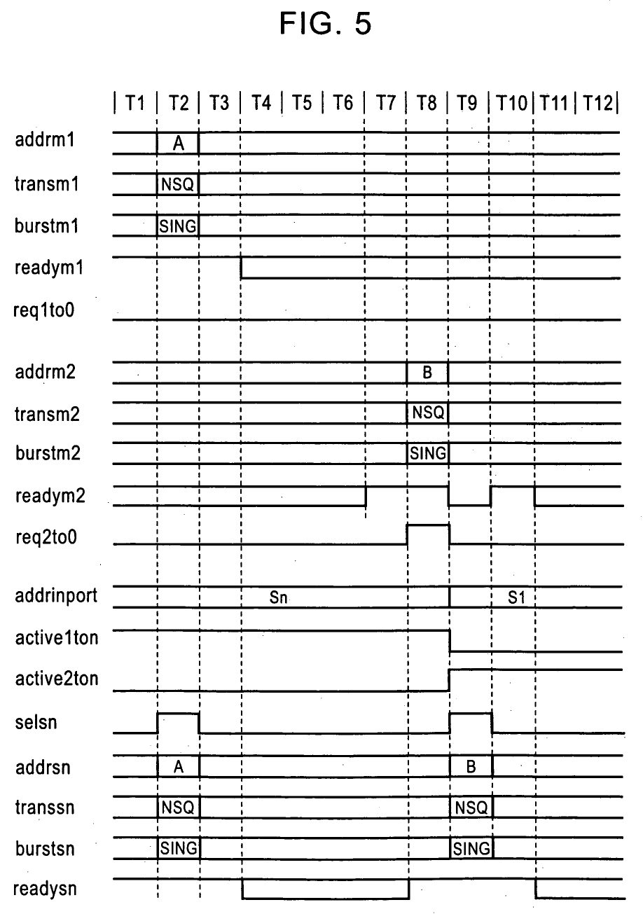

FIG. 5 depicts an example of the operation timing of the system shown in FIG. 1.

In this example, the arbitration circuit 13A does not perform the arbitration operation at the first access. At the second access, the arbitration circuit 13A performs the arbitration operation since this is an access from a master device other than the master device which accessed the last time.

In initial status, it is assumed that the last access to the slave device 2ₙ is from the master device 11.

At the cycle T2, the address addrm1 is supplied to the bus of the master device 1₁ from the master device 1ₗ, and then supplied to the control device. At the cycle T2, the connection control signal active1ton, which indicates enabling the use of the bus of the slave device 2ₙ, has already been output, so that the access of the address addrm1=A, which is supplied to the bus of the master device 1ₗ, is directly output to the bus of the slave device 2ₙ without a delay. At this time, the access request signal req1ton from the master device 1₁ to the slave device 2ₙ is not supplied to the arbitration circuit 13Aₙ.

At the cycle T8, when the access of the addrm2=B is made from the master device 1₂, which is a master device other than the master device 1₁ that accessed the last time, the access request signal req2ton from the master device 1₂ to the slave device 2ₙ is transferred to the arbitration circuit 13Aₙ.

In response to the access request signal req2ton, the arbitration circuit 13An starts the arbitration operation, and generates the connection control signal active2ton at the cycle T9. After the cycle T9, the master 12 can therefore access the slave 2ₙ.

This application is based on Japanese Patent Application No. 2004-118027 filed on Apr. 13, 2004, and the entire disclosure thereof is incorporated herein by reference.

1. A matrix type bus connection system, comprising:
a plurality of master devices;
a plurality of slave devices;
a plurality of first dedicated buses extending from the plurality of master devices, respectively, such that each said master device is able to request connection to a connection target slave device among said plurality of slave devices by outputting an address of the connection target slave device to the first dedicated bus;
a plurality of second dedicated buses extending from the plurality of slave devices, respectively, such that each said slave device is able to transfer data to said master device that has requested the connection through the second dedicated bus, when connection is established between the first dedicated bus of the master device concerned and the second dedicated bus of the slave device concerned;
a plurality of decoders associated with the plurality of master devices respectively such that each said decoder analyzes the address of the connection target slave device issued from the associated master device to specify the connection target slave device, and to output a connection request signal to the connection target slave device;
a plurality of arbitration circuits associated with the plurality of slave devices respectively such that said arbitration circuit associated with the connection target slave device performs connection control to establish the connection between the first dedicated bus of said master device concerned and the second dedicated bus of said connection target slave device and issues a select signal based on the connection request signal provided by said decoder; and
a selector for connecting, according to the select signal provided by said arbitration circuit, the first dedicated bus of the master device and the second dedicated bus of the connection target slave device, wherein said arbitration circuit stores an address of the master device that has now established the connection to the connection target slave device and when receiving a connection request from the same master device again, omits the connection control.

2. The matrix type bus connection system according to claim 1, wherein each said arbitration circuit keeps the select signal, even after the connection between the master device and the connection target slave device ends.

3. The matrix type bus connection system according to claim 1, wherein if a plurality of connection request signals are issued to a single connection target slave device from a plurality of said master devices, said arbitration circuit associated with the connection target slave device selects one of said master devices based on when the connection request signals reach the arbitration circuit, and performs the connection control to establish the connection between the selected master device and the connection target slave device.

4. The matrix type bus connection system according to claim 1, wherein each said master device is a CPU (Central Processing Unit) or DMA (Direct Memory Access).

5. The matrix type bus connection system according to claim 4, wherein each said slave device is a data storing unit.

6. A matrix type bus connection system, comprising:
a plurality of slave devices;
a plurality of master devices, each said master device being able to make a connection request to a target slave device among said plurality of slave devices;
a plurality of arbitration circuits associated with the plurality of slave devices respectively such that said connection request from said master device is sent to said arbitration circuit associated with the target slave device, and said arbitration circuit concerned performs connection control for establishment of the connection between said master device concerned and the said target slave device and then issues a select signal, based on the connection request sent from said master device; and
a controller connected to said plurality of arbitration circuits for deciding whether connection between the master device and the target slave device should be permitted, based on the select signal;
wherein when the arbitration circuit associated with the target slave device receives a connection request from the same master device again, the controller prohibits the arbitration circuit from performing the connection control, so that the arbitration circuit immediately issues the select signal to cause the controller to immediately permits the connection between the master device and the target slave device.

7. The matrix type bus connection system according to claim 6, wherein each said arbitration circuit keeps the select signal, even after the connection between the master device and the target slave device ends.

8. The matrix type bus connection system according to claim 6, wherein if a plurality of connection request signals are issued to a single target slave device from a plurality of said master devices, said arbitration circuit associated with the target slave device selects one of said master devices based on when the connection request signals reach the arbitration circuit, and performs the connection control to establish the connection between the selected master device and the target slave device.

9. The matrix type bus connection system according to claim 6, wherein said master device sends identification information of itself together with the connection request, and the controller determines that the arbitration circuit associated with the target slave device receives the connection request from the same master device when the identification information appended with the connection request matches the identification information of the master device which made the connection request last time.

10. The matrix type bus connection system according to claim 6, wherein each said master device is a CPU (Central Processing Unit) or DMA (Direct Memory Access).

11. The matrix type bus connection system according to claim 10, wherein each said slave device is a data storing unit.
